(19) United States
(12) Patent Application Publication
(10) Pub. No.: US 2016/0057384 A1
(43) Pub. Date: Feb. 25, 2016

(54) DEVICE AND SYSTEM FOR FACILITATING TWO-WAY COMMUNICATION

(71) Applicant: Maria Nakamura, Plantation, FL (US)

(72) Inventor: Maria Nakamura, Plantation, FL (US)

(21) Appl. No.: 14/830,883

(22) Filed: Aug. 20, 2015

Related U.S. Application Data
(60) Provisional application No. 62/039,538, filed on Aug. 20, 2014.

(51) Int. Cl. H04N 7/14

(52) U.S. Cl. CPC H04N 7/141; H04N 7/142; H04W 84/18

(57) ABSTRACT

A toy-shaped communication device for facilitating communication between a child and a remote caretaker over a long range communication network is disclosed having a body resembling a child's toy. The body at least partially encapsulates at least one network connection operably configured to communicate over a long range communication network; and a processor operable to execute computer instructions for receiving, over the long range communication network, a communication from a caretaker's remote electronic mobile device. The communication includes at least one of an audio and a visual communication recorded by the caretaker's remote electronic mobile device. The toy-shaped communication device also has an output terminal operable to output the audio and visual communication recorded by the caretaker's remote electronic mobile device to a child disposed proximate the body.

### CROSS-REFERENCE TO RELATED APPLICATION

This application claims the benefit of U.S. Provisional Patent Application No. 62/039,538 filed Aug. 20, 2014, the entirety of which is incorporated by reference.

### FIELD OF THE INVENTION

The present invention relates generally to communication devices and systems, and, more particularly, relates to a communication device and system for facilitating two-way communication over a network.

### BACKGROUND OF THE INVENTION

It is well known that parents are often otherwise engaged, exhausted, and otherwise unable to be in the same physical location as their children. Communication between parents and children plays a vital role in child development, however, especially in a child's early years. Parents who wish to communicate directly with their child, while unable to be physically present with the child, often utilize electronic communication devices, such as smart phones, to communicate with their child. Communicating with a child through a smart phone, however, often requires calling an intermediary, for example a babysitter, who then has to hold the phone to the child's ear so that the child can hear the parent's voice. Existing software programs, such as Skype, Face-time, and other similar programs that facilitate video calls, also require the use of an adult intermediary, because very small children, such as infants and toddlers, do not possess the knowledge or ability to operate such programs.

A known communication system, such as a baby monitor, allows parents to monitor their child when the child is in a separate room within a house, an apartment, or other structure. Known baby monitors, however, are often fraught with problems. In particular, known baby monitors are only able to operate over short distances and are therefore limited to in-home use only. Accordingly, when parents are not at home, e.g. traveling or at work, such baby monitors are not able to provide parents with monitoring or communication capabilities. Additionally, many of the known baby monitors provide for one-way communication, allowing the parent to view and/or hear the child, yet the child is unable to view and/or hear the parent.

Therefore a need exists to overcome the problems with the prior art as discussed above.

### SUMMARY OF THE INVENTION

The invention provides a device and system for facilitating two-way communication that overcomes the hereinafore-mentioned disadvantages of the heretofore-known devices and methods of this general type.

With the foregoing and other objects in view, there is provided, in accordance with the invention, a toy-shaped communication device for facilitating communication between a child and a remote caretaker over a long range communication network, the toy-shaped communication device having a body resembling a child's toy. The body at least partially encapsulates at least one network connection operably configured to communicate over a long range communication network; and a processor communicatively coupled to the network connection, the processor operable to execute a computer instruction set with instructions for receiving, over the long range communication network, a communication from a caretaker's remote electronic mobile device, the communication including at least one of an audio and a visual communication recorded by the caretaker's remote electronic mobile device. The toy-shaped communication device further includes an output terminal communicatively coupled to the processor, the output terminal operable to output the audio and visual communication recorded by the caretaker's electronic mobile device to a child disposed proximate the body.

In accordance with another feature, an embodiment of the present invention further includes a sensor communicatively coupled to the processor and operably configured to record at least one of an audio and a visual communication of the child disposed proximate the body. The processor is further operable to execute instructions for transmitting, over the long range communication network, the audio and the visual communication of the child recorded by the sensor to the caretaker's electronic mobile device.

In accordance with yet another feature of the present invention, the sensor is formed as a video camera.

In accordance with a further feature of the present invention, the caretaker's electronic mobile device is formed as a cellular mobile device.

In accordance with yet a further feature of the present invention, the body is formed as a stuffed animal.

In accordance with another feature of the present invention, the long range communication network is at least one of the Internet or a cellular communications network.

In accordance with another feature of the present invention, the output terminal is a computer display operable to display the visual communication recorded by the caretaker's electronic mobile device on the computer display for the child to view.

In accordance with yet another feature of the present invention, the audio and visual communication recorded by the caretaker's electronic mobile device is presented to the child, via the output terminal, as a result of the child activating an actuator disposed on the body.

In accordance with a further feature of the present invention, an embodiment further includes a sensor communicatively coupled to the processor and operably configured to detect a child's cry; and the audio and visual communication recorded by the caretaker's electronic mobile device is presented to the child, via the output terminal, as a result of the sensor detecting the child's cry.

In accordance with yet a further feature of the present invention, an embodiment further includes a sensor communicatively coupled to the processor and operably configured to detect a pressure measurement; and the audio and visual communication recorded by the caretaker's electronic mobile device is presented to the child, via the output terminal, as a result of the sensor detecting a hugging pressure exerted on the body.

In accordance with another embodiment of the present invention, a child-monitoring communication system for two-way communication over a long range communication network between a remote caretaker and a child is provided. The system includes a toy-shaped communication device having a body resembling a child's toy and an output terminal, a first sensor, and a caretaker cellular mobile device. The toy-shaped communication device receives, over a long range communication network, at least one of an audio and a visual communication from a remote caretaker; and outputs the audio and the visual communication from the remote caretaker to the output terminal. The first sensor is communicatively coupled to the toy-shaped communication device and is operably configured to record at least one of an audio and a visual communication of a child disposed proximate the body of the toy-shaped communication device. The caretaker cellular mobile device has a second sensor operable to record the audio and the visual communication from the remote caretaker; and at least one network connection operably configured to receive, over the long range communication network, the audio and the visual communication of the child recorded by the first sensor and transmit, over the long range communication network, the audio and the visual communication of the remote caretaker recorded by the second sensor to the toy-shaped communication device.

In accordance with another embodiment of the present invention, the first sensor is at least partially encapsulated by the body.

In accordance with yet another embodiment of the present invention, the first sensor is a video camera.

In accordance with an additional embodiment of the present invention, the body is of a plush material.

In accordance with another embodiment of the present invention, the body is formed as a stuffed animal.

In accordance with yet another embodiment of the present invention, the long range communication network is at least one of the Internet or a cellular communications network.

In accordance with a further embodiment of the present invention, the output terminal is a computer display operable to display the visual communication from the remote caretaker on the computer display for the child to view.

In accordance with yet a further embodiment of the present invention, the audio and visual communication from the remote caretaker is presented to the child, via the output terminal, as a result of the child activating an actuator disposed on the body.

In accordance with another embodiment of the present invention, the toy-shaped communication device includes a third sensor operably configured to detect a child's cry; and the audio and visual communication from the remote caretaker is presented to the child, via the output terminal, as a result of the third sensor detecting the child's cry.

In accordance with yet another embodiment of the present invention, the toy-shaped communication device includes a third sensor operably configured to detect a pressure measurement; and the audio and visual communication from the remote caretaker is presented to the child, via the output terminal, as a result of the third sensor detecting a hugging pressure exerted on the body.

Although the invention is illustrated and described herein as embodied in a device and system for facilitating two-way communication, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the toy-shaped body. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a schematic diagram of a child-monitoring communication system that may be operably configured to implement a method of facilitating communication over a network between a caretaker and a child in accordance with the present invention;

FIG. 2 is a block diagram of an exemplary electronic device used within the child-monitoring communication system in accordance with the present invention; and

FIG. 3 is a process flow chart representing an exemplary method implemented through a software application provided on a caretaker's electronic device, for facilitating two-way remote communication over a network in accordance with the present invention.

### DETAILED DESCRIPTION

Although the invention is illustrated and described herein as embodied in device and system for facilitating two-way communication, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. The figures of the drawings are not drawn to scale.

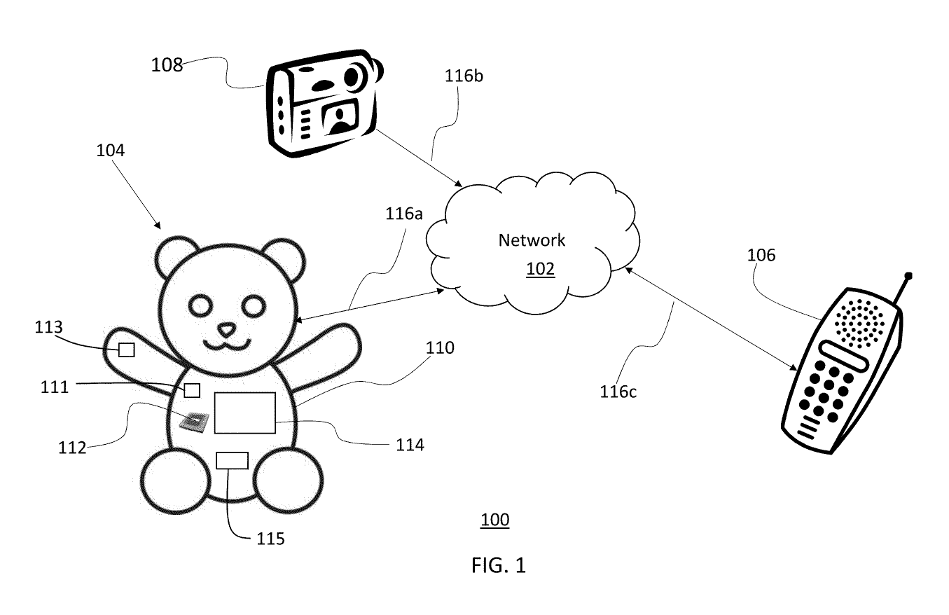

With reference to FIG. 1, the present invention provides a novel child-monitoring two-way communication system 100 for facilitating remote dual-communication over a network between a caretaker and a child. The term “caretaker” is defined herein as an adult who provides care to a child. For example, the caretaker may be a parent, a step-parent, a guardian, a baby sitter, an overseer of the child, or the like. Embodiments of the present invention provide a plush toy including an electronic communication device operable to receive audio and visual communications from a caretaker's electronic communication device, e.g. cellular mobile device or computer tablet, and, also, send audio and visual communications detected by the plush toy device to the caretaker's electronic communication device. This facilitates two-way communication whereby children can receive communication from their parents, even when parents are not physically within the home, and, at the same token, parents can monitor their children when they are away, by receiving visual and audio communications recorded and transmitted by the plush toy device. In one embodiment, pre-existing one-way baby monitor devices can be upgraded to two-way systems by including the plush toy device and, also downloading a software application configured to facilitate two-way communication with the plush toy device onto the caretaker's electronic communication device.

FIG. 1 depicts an embodiment of the presently inventive child-monitoring two-way communication system 100. FIG. 1 shows several advantageous features of the present invention, but, as will be described below, the invention can be provided in several shapes, sizes, combinations of features and components, and varying numbers and functions of the components. As illustrated in the embodiment of FIG. 1, the child-monitoring two-way communication system 100 includes a plush toy device 104, a caretaker's electronic device 106, and at least one sensor 108, communicatively coupled over a network 102. The network 102 is used to provide communication links 116a-c between various devices and computers communicatively coupled together within the presently inventive two-way communication system 100. The network 102 may include wired and/or wireless connections. The network 102 is preferably a wide-area network (WAN) operable to facilitate remote two-way communication over very long distances. In an embodiment, the network 102 may be the Internet. In another embodiment, the network 102 may be a cellular network.

Plush Toy Device

The plush toy device 104 is a plush toy that is operable to receive, process and output communications sent between the caretaker's electronic device 106 and the plush toy device 104 over the network 102. In this first embodiment of FIG. 1, the plush toy device 104 is shown having a plush toy body 110 encapsulating an electronic system including a processor 112 communicatively coupled to an output terminal 114. The output terminal 114 can be considered an output device that outputs communications from a remote caretaker to the child. In one embodiment, the output terminal 114 may be a speaker that outputs audio communications from the remote caretaker to the child. In another embodiment, the output terminal 114 may be a computer display that outputs video or visual communications from the remote caretaker to the child. For example, the output terminal 114 may include a computer display coupled to a speaker that outputs video recordings of the caretaker for the child to view. The video recordings may be prerecorded video recordings of the caretaker, or real-time streaming of the video. As used herein, the term “prerecord” is intended to indicate recording or capturing an event (e.g., photo or video of an event) for later use.

The term “plush” is defined herein as a soft material. In other embodiments, the toy device 104 can be formed as a toy with a rigid or semi-rigid body, such as a toy truck, an action figurine, or a Barbie doll. In another embodiment, the present invention can be considered a toy-shaped communication device with a body resembling a child's toy. Referring still to FIG. 1, the plush toy body 110 is shown as a stuffed teddy bear. The design of the plush toy body 110 is intended to bring joy and comfort to a child. In another embodiment, the plush toy body 110 may be formed as another type of stuffed animal, such as a lamb, a frog, a dog, a cartoon character, or another similar plush toy. As used herein, the term “stuffed animal” is defined as a child's toy-shaped body made with fabric and filled with a soft stuffing material. In one embodiment, the plush toy body 110 may include one or more sensors 111 or 108, such as a video camera or a microphone, to record video and audio of the child, which can subsequently be sent to the caretaker's electronic device 106, via, for example, the Internet.

Communication from Caretaker to Child

In one embodiment, the communication from the caretaker to the child may be accomplished by sending a communication from the caretaker's electronic device 106 to the plush toy device 104 over the network 102. The caretaker's electronic device 106 may be, for example, a smart phone, a computer tablet, or another similar electronic device. In yet another embodiment, the caretaker's electronic device 106 may be a desktop computer. In an embodiment, the communication may be in the form of at least one of an audio communication and a visual communication. In another embodiment, the communication may be in the form of audio and visual communications. Advantageously, the caretaker can send pictures, videos, audio messages, or the like, to the plush toy device 104, located in close proximity to the child, for the child's listening and viewing pleasure. Presentation of pictures, videos, audio messages, and the like, can be presented to the child via the plush toy device 104 in many ways, such as, automatically when downloaded, at predetermined user-selected times, through the child's activation of an actuator 113 located on the plush toy device 104, or when a sensor 115 coupled to the plush toy device 104 detects, for example, a crying sound or a pressure measurement from a child's hug. Advantageously, embodiments of the present invention are configured such that an adult intermediary (e.g., babysitter) is not required in order for the child to receive communications from the remote caretaker (e.g., working parent). In one embodiment, the actuator 113 is a button coupled to the plush toy device 104 that the child can press to activate communication. As used herein, the term “actuator” is intended to indicate a mechanical or electrical device for moving or controlling something. In one embodiment, the sensor 115 may be an audio sensor operable to detect a child's cry. In another embodiment, the sensor 115 may be a pressure sensor operable to detect a pressure exerted on the plush toy body 110, such as, for example, a child's hug or a child squeezing a teddy bear's hand, or the like. In an aspect, the caretaker is provided with a sense of comfort in knowing that even though he or she is not physically present with the child, the child can still receive the caretaker's attention and recognition.

In one exemplary embodiment, the communication from the caretaker's electronic device 106 is an audio communication captured by a sensor of the caretaker's electronic device 106. In this embodiment, the sensor may be a microphone. The audio communication may be, for example, a representation of the caretaker's voice. The caretaker may prerecord the audio, which audio file can then be downloaded to the plush toy device 104 via the network 102. In this embodiment, the child can play the audio recording by, for example, hugging the plush toy device 104 or pressing the actuator 113 on the plush toy device 104. In other embodiments, the prerecording can be automatically played at predetermined user-selected time periods. For example, the prerecording may be configured to play at the child's normal bedtime, or when the child normally wakes up in the morning. In one embodiment, the caretaker may communicate audibly with the child in real-time, with the caretaker's electronic device 106 streaming the audio communication in real-time over the network 102 to the plush toy device 104. For example, when the caretaker is unable to be physically present with the child at the child's bedtime, the communication system 100 facilitates the communication of a bedtime story to the child in real-time. In the event the bedtime story, or other audio or visual communication, is prerecorded, the communication can be stored in the memory on the caretaker's electronic device 106 or the plush toy device 104 and then output to the output terminal 114 for the child at a later desired time. In another embodiment, the prerecorded communication can be downloaded from the caretaker's electronic device 106 to the plush toy device 104 and played for the child as a result of, for example, the actuator 113 being activated by the child. In yet another embodiment, the communication may be soothing music operable to provide comfort to the child. In one embodiment, the music can be accompanied by the caretaker's voice singing to the music.

In another embodiment, the communication from the caretaker's electronic device is a visual communication captured by a sensor of the caretaker's electronic device 106. In this embodiment, the sensor may be a camera, capable of taking pictures and/or recording video. In an embodiment, the visual communication may represent a picture of the caretaker. In another embodiment, the visual communication may represent video footage of the caretaker. In yet another embodiment, the visual communication may represent a photograph or video footage of another subject, taken by the caretaker. In this manner, virtual presence and comfort can be communicated to the child from the caretaker, even though the caretaker is not physically present with the child.

In yet another embodiment, the communication is an audio and visual communication captured by a plurality of sensors of the caretaker's electronic device 106. In this embodiment, the sensors may include a microphone and a camera, operable to transmit, for example, a video with audio, to the plush toy device 104. In one embodiment, the caretaker may communicate video with audio in real-time to the child, through the caretaker's electronic device 106 streaming the audio-visual communications in real-time over the network 102 to the plush toy device 104 while the caretaker is recording the audio-video footage. In some embodiments, the caretaker's electronic device 106 is able to simultaneously receive audio-video footage of the child and send audio-video footage of the caretaker to the plush toy device 104 via the network 102. This simultaneous two-way communication between the child and caretaker provides both individuals with the feeling of being present with one another.

The processor 112 is operable to execute a computer instruction set for receiving the communication from the caretaker's electronic device 106 over the network 102. The instruction set can be stored in memory communicatively coupled to the processor 112. Preferably, the memory is non-volatile memory. In an embodiment, the processor 112 is removably coupled to the plush toy body 110. FIG. 1 shows the processor 112 removably coupled to the plush toy body 110 by being sewn into the plush toy body 110. In another embodiment, the plush toy body 110 may include a pocket or a cavity within the plush toy body 110, operable to receive the processor 112 therein in order to removably couple the processor 112 to the plush toy body 110. In one embodiment, the processor 112 is powered by a battery. In another embodiment, the processor 112 may be powered by an AC adapter, though the battery powered configuration is preferred because it is not desirable to have exposed wiring near the child. In one embodiment, the processor 112 is communicatively coupled to a wireless transmitter and a wireless receiver, for transmitting audio, video, and other communication communications to the caretaker's electronic device 106 and receiving audio, video, and other communication communications from the caretaker's electronic device 106, respectively.

The output terminal 114 is operable to output at least one of the audio communication and the visual communication for presentation to the child. In one embodiment, the output terminal 114 is coupled to the plush toy body 110 and communicatively coupled to the processor 112. In another embodiment, the output terminal 114 is operable to output the audio communication and the visual communication for presentation to the child proximate the plush toy device 104. Advantageously, the presently inventive child-monitoring two-way communication system 100 is configured such that the child is located in close proximity to the plush toy device 104 so that the child can hear the audio communication and view the visual communication from the output terminal 114. In an embodiment, the output terminal 114 may be a speaker, wherein the speaker is operable to output the audio communication from the caretaker's electronic device 106. Advantageously, through the speaker, the child is able to hear the caretaker's voice which may provide comfort to the child when, for example, the child is crying and upset. In another embodiment, the output terminal 114 may be a display screen. The display screen may be operable to output the visual communication from the caretaker's electronic device 106. In an embodiment, the display screen may include a removable cover, operable to cover the display screen at a desired time of day or night. Advantageously, through the display screen, the child is able to view photographs or video of the caretaker, when the caretaker is not able to be physically present with the child. This feature is designed to provide comfort to the child and to facilitate communication between the caretaker and child, which is very important for the child's development. In yet another embodiment, there are a plurality of output terminals 114, which may include, for example, a speaker and a display screen. This is the preferred embodiment of the communication system 100, because the child may receive maximum comfort and interaction with the caretaker through the use of both audio and visual communications.

In an embodiment, communication from the caretaker to the child through the communication system 100 may be initiated by the child hugging the plush toy device 104. In this embodiment, the plush toy device 104 may include a motion or a pressure sensor configured to detect a hug and communicate with the processor 112 in order to request audio and/or visual communications from the caretaker's electronic device 106. In another embodiment, communication from the caretaker to the child through the communication device 100 may be initiated by the sound of the child (e.g. when the child is crying), captured by the sensor 115 within the plush toy device 104 and communicated to the caretaker's electronic device 106. The caretaker may then communicate an audio and a visual communication to the child from the caretaker's electronic device 106. In yet another embodiment, the caretaker may receive a prompt on a display of the caretaker's electronic device 106, notifying the caretaker of a hug or a cry event detected by the plush toy device 104 and asking the caretaker whether he or she would like to communicate an audio and/or a visual communication to the plush toy device 104, or receive audio and/or visual communications from the child via the plush toy device 104. In one embodiment, audio and/or visual communications may be prerecorded by the caretaker's electronic device 106 and then downloaded and stored in non-transitory memory communicatively coupled to the processor 112. Accordingly, when the sensor 115 detects, for example, a hug or a cry event, the prerecorded audio and/or visual communications can be automatically retrieved from the memory and presented to the child via the output terminal 114, whether or not a network connection is established with the caretaker's electronic device 106.

In another embodiment, the caretaker may initiate communication from the caretaker's electronic device 106 to the child. The communication may be the audio and visual communication. In yet another embodiment, the audio communication and the visual communication may be coupled to a timer. For example, the timer may be set to communicate the audio communication and the video communication to the plush toy device 104 at the child's usual bedtime. In another embodiment, there may be one or more touchscreen buttons or other indicators on the caretaker's electronic device 106 that the caretaker can press/touch in order to initiate selected communications to the child. For example, there may be one button for playing a prerecorded story; one button for streaming live video; one button displaying a saved digital photograph; one button for playing an audio file including the caretaker's voice singing the child's favorite song; etc. The caretaker can press the button at any time in order to initiate any of the activities. In one embodiment, these buttons may be provided by a software application running on the caretaker's electronic device 106

Communication from Child to Caretaker

The communication from the child to the caretaker may be accomplished by sending a communication from the sensor 108 and/or 111, such as a camera or a microphone located at or near the child's crib, to the caretaker's electronic device 106 over the network 102. In an embodiment, the sensor 108 facilitates visual communication from the child to the caretaker's electronic device 106 over the network 102. In another embodiment, the sensor 108 facilitates audio communication so that the caretaker can hear the child's voice. In another embodiment, the sensor 108 is a video camera that provides visual and audio communication from the child to the caretaker. FIG. 1 shows the sensor 108 as video camera. In another embodiment, the sensor 108 may be a microphone. In an embodiment, the sensor 108 is removably coupled to the plush toy device 104. FIG. 1 shows the sensor 108 as a separate component from the plush toy device 104, which is communicatively coupled to the plush toy device 104 via the network 102. For example, the sensor 108 may be a video camera attachable proximate to the child's crib for capturing video data of the child while in his crib. In one embodiment, the video camera can be communicatively coupled to the plush toy device 104 via a short range wireless communication network (e.g., Blueooth). In another embodiment, the video camera can be communicatively coupled to the plush toy device 104 over a WAN, such as the Internet or a cellular network. In another embodiment, the video camera is disposed within the plush toy body 110, with the camera lens operable to view an environment external to the plush toy body 110, e.g. the crib area in which the plush toy device 104 may sit. In some embodiments, the video camera is a separate component from the plush toy device 104, because if the camera were connected to the plush toy device 104, the camera lens could become blocked from time to time and therefore unable to capture images or video footage of the child when the plush toy device 104 is, for example, laying in a position such that the video camera lens is faced down, as may often happen with children's plush toys. In another embodiment, the audio and/or visual communications of the child can be captured or recorded by a sensor disposed within the plush toy body 110, such as the sensor 111. The sensor 111 may be, for example, a microphone, a camera, a video camera, or the like, operable to record the child.

In one embodiment, communication from the child to the caretaker can be initiated by an actuator button or other sensor within the plush toy device 104. For example, as discussed above, an audio and/or pressure sensor included the plush toy device 104 can detect a cry or a hug event, respectively, which can initiate various events, such as, for example, playing prerecorded messages, pictures, audio, and video stored in non-transitory memory on the plush toy device 104; streaming audio-video to the caretaker's electronic device 106; and/or requesting that audio-video be streamed from the caretaker's electronic device 106 to the plush toy device 104.

Hardware

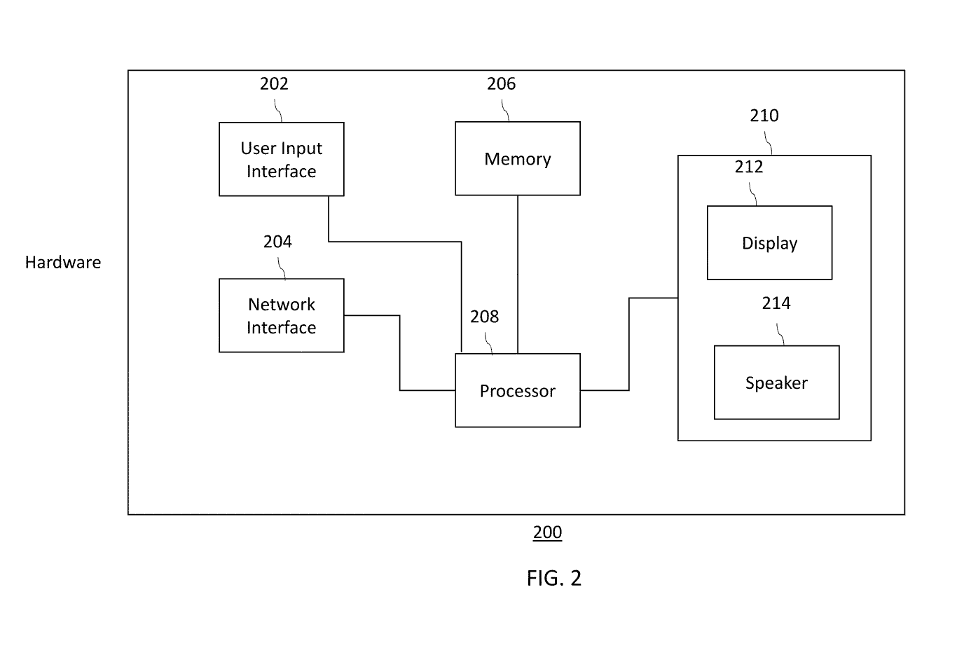

FIG. 2 illustrates an exemplary data processing system 200 that can be implemented as a computer system, such as the plush toy device 104 and the caretaker's electronic device 106, operable to implement the inventive process. The data processing system 200 can include a user input interface 202, a network interface 204, memory 206, a processor 208, and an output interface 210.

The user input interface 202 can be a keyboard, a mouse, a touchscreen, a microphone, or any other interface operable to receive user input. The output interface 210 can be, for example, a display 212 and a speaker 214 operable to output video and audio communications to the user. The display 212 may be any suitable type of display, such as a liquid-crystal display (LCD), a plasma display, a light-emitting diode (LED) display, or the like.

The network interface 204 facilitates communication between the data processing system 200 and other data processing systems or peripheral components via one or more networks, such as the network 102 (see FIG. 1). The network interface 204 may include a local area network (LAN) interface. The LAN interface may be, for example, an interface to a wireless LAN, such as a Wi-Fi network. In one embodiment, there is a wireless LAN located within the child's residence that provides the plush toy device 104 (see FIG. 1) with access to the Internet for receiving and sending the two-way communications between the plush toy device 104 and the caretaker's electronic device 106 (see FIG. 1). Typically, a connection between two electronic devices via the LAN interface may involve communication through a network router or other intermediary device. Additionally, the network interface 204 may include the capability to connect to a wide area network (WAN) via a WAN interface. The WAN interface may permit a connection to a cellular mobile communications network. The WAN interface may include communications circuitry, such as an antenna coupled to a radio circuit having a transceiver for transmitting and receiving radio communications via the antenna. The radio circuit may be configured to operate in a mobile communications network, including but not limited to global systems for mobile communications (GSM), code division multiple access (CDMA), wideband CDMA (WCDMA), and the like. Communications between the plush toy device 104 and the caretaker's electronic device 106 is preferably over a long range communication network, such as the Internet or a cellular mobile communications network. As used herein, the phrase “long range communication” is intended to indicate a communication channel that can facilitate communications over very long distances, on the order of counties, cities, states, nations, regions, and/or countries.

The memory 206 stores computer instructions that can be executed by the processor 208 in order to implement the inventive process. The memory 206 may be, for example, one or more buffers, a flash memory, or non-volatile memory, such as random access memory (RAM). The memory 206 may also include non-volatile storage. The non-volatile storage may represent any suitable storage medium, such as a hard disk drive or non-volatile memory, such as flash memory.

The processor 208 can be, for example, a central processing unit (CPU), a microcontroller, or a microprocessing device, including a “general purpose” microprocessing device or a special purpose microprocessing device. The processor 208 executes code stored in memory 206 in order to carry out operation/instructions of the data processing system 200. The processor 208 may provide the processing capability to execute an operating system, run various applications, and provide processing for one or more of the techniques described herein.

Process for Providing Remote Two-Way Communications Between a Child and a Caretaker

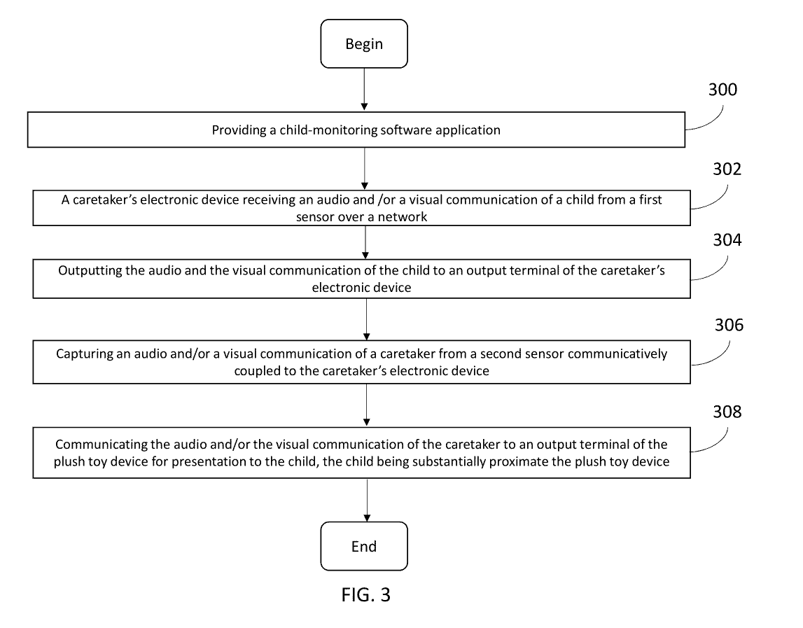

FIG. 3 will be described in conjunction with the network diagram of FIG. 1. FIG. 3 shows a process flow chart representing an exemplary method for facilitating two-way communication over the network 102 in accordance with the present invention.

Although FIG. 3 shows a specific order of executing the process steps, the order of executing the steps may be changed relative to the order shown in certain embodiments. Also, two or more blocks shown in succession may be executed concurrently or with partial concurrence in some embodiments. Certain steps may also be omitted in FIG. 3 for the sake of brevity. In some embodiments, some or all of the process steps included in FIG. 3 can be combined into a single process.

The presently inventive process can include, in step 300, providing a child-monitoring software application. In one embodiment, the software application can be implemented as a smart phone app that facilitates the two-way communication between the caretaker's electronic device 106 and the plush toy device 104. In another embodiment, the software application can be downloaded, stored, and executed by the caretaker's electronic device 106, which may be implemented as a smart phone. In an exemplary embodiment, the child-monitoring software application includes instructions associated with transmitting, controlling, and communicating the audio and/or visual communications over the network 102, in accordance with the present invention.

In step 302, the caretaker's electronic device 106 receives an audio communication and/or a video communication of the child from a first sensor, such as the sensor 108 or 111, over the network 102. The first sensor can be, for example, a video camera associated with the plush toy device 104. In step 304, the caretaker's electronic device 106 can output the audio communication and/or the video communications of the child to an output terminal communicatively coupled to the caretaker's electronic device 104. The output terminal can be, for example, a display or a speaker on the caretaker's electronic device 106. In step 306, the caretaker's electronic device 106 captures an audio communication and/or a video communication of the caretaker from a second sensor communicatively coupled to the caretaker's electronic device 106. The audio and/or visual communication of the caretaker can be, for example, a picture or a video of the caretaker captured/recorded by the caretaker's electronic device 106. In step 308, the caretaker's electronic device 106 communicates the audio communication and/or the video communication of the caretaker to the output terminal 114 of the plush toy device 104 for presentation to the child. Ideally, the child is substantially proximate the plush toy device 104. The second sensor can be a video camera or a microphone associated with the caretaker's electronic device 106. The output terminal 114 of the plush toy device 104 can be, for example, a display or a speaker on the plush toy device 104.

What is claimed is:

1. A toy-shaped communication device for facilitating communication between a child and a remote caretaker over a long range communication network, the toy-shaped communication device comprising:
a body resembling a child's toy, the body at least partially encapsulating:
at least one network connection operably configured to communicate over a long range communication network;
a processor communicatively coupled to the at least one network connection, the processor operable to execute a computer instruction set comprising instructions for:
receiving, over the long range communication network, a communication from a caretaker's remote electronic mobile device, the communication including at least one of an audio and a visual communication recorded by the caretaker's remote electronic mobile device; and
an output terminal communicatively coupled to the processor, the output terminal operable to output the at least one of the audio and visual communication recorded by the caretaker's electronic mobile device to a child disposed proximate the body.

2. The toy-shaped communication device according to claim 1, further comprising:
a sensor communicatively coupled to the processor and operably configured to record at least one of an audio and a visual communication of the child disposed proximate the body; and
wherein the processor is further operable to execute instructions for:
transmitting, over the long range communication network, the at least one of the audio and the visual communication of the child recorded by the sensor to the caretaker's electronic mobile device.

3. The toy-shaped communication device according to claim 2, wherein:
the sensor is formed as a video camera.

4. The toy-shaped communication device according to claim 1, wherein:
the caretaker's electronic mobile device is formed as a cellular mobile device.

5. The toy-shaped communication device according to claim 1, wherein:
the body is formed as a stuffed animal.

6. The toy-shaped communication device according to claim 1, wherein:
the long range communication network is at least one of the Internet or a cellular communications network.

7. The toy-shaped communication device according to claim 1, wherein:
the output terminal is a computer display operable to display the visual communication recorded by the caretaker's electronic mobile device on the computer display for the child to view.

8. The toy-shaped communication device according to claim 1, wherein:
the at least one of the audio and visual communication recorded by the caretaker's electronic mobile device is presented to the child, via the output terminal, as a result of the child activating an actuator disposed on the body.

9. The toy-shaped communication device according to claim 1, further comprising:
a sensor communicatively coupled to the processor and operably configured to detect a child's cry; and
wherein the at least one of the audio and visual communication recorded by the caretaker's electronic mobile device is presented to the child, via the output terminal, as a result of the sensor detecting the child's cry.

10. The toy-shaped communication device according to claim 1, further comprising:
a sensor communicatively coupled to the processor and operably configured to detect a pressure measurement; and
wherein the at least one of the audio and visual communication recorded by the caretaker's electronic mobile device is presented to the child, via the output terminal, as a result of the sensor detecting a hugging pressure exerted on the body.

11. A child-monitoring communication system for two-way communication over a long range communication network between a remote caretaker and a child, the system comprising:
a toy-shaped communication device having a body resembling a child's toy and an output terminal, the toy-shaped communication device:
receives, over a long range communication network, at least one of an audio and a visual communication from a remote caretaker; and
outputs the at least one of the audio and the visual communication from the remote caretaker to the output terminal;
a first sensor communicatively coupled to the toy-shaped communication device and operably configured to record at least one of an audio and a visual communication of a child disposed proximate the body of the toy-shaped communication device; and
a caretaker cellular mobile device having:
a second sensor operable to record the at least one of the audio and the visual communication from the remote caretaker; and
at least one network connection operably configured to receive, over the long range communication network, the at least one of the audio and the visual communication of the child recorded by the first sensor and transmit, over the long range communication network, the at least one of the audio and the visual communication of the remote caretaker recorded by the second sensor to the toy-shaped communication device.

12. The child-monitoring communication system in accordance with claim 11, wherein:
the first sensor is at least partially encapsulated by the body.

13. The child-monitoring communication system in accordance with claim 11, wherein:
the first sensor is a video camera.

14. The child-monitoring communication system in accordance with claim 11, wherein:
the body is of a plush material.

15. The child-monitoring communication system in accordance with claim 11, wherein:
the body is formed as a stuffed animal.

16. The child-monitoring communication system in accordance with claim 11, wherein:
the long range communication network is at least one of the Internet or a cellular communications network.

17. The child-monitoring communication system in accordance with claim 11, wherein:
the output terminal is a computer display operable to display the visual communication from the remote caretaker on the computer display for the child to view.

18. The child-monitoring communication system in accordance with claim 11, wherein:
the at least one of the audio and visual communication from the remote caretaker is presented to the child, via the output terminal, as a result of the child activating an actuator disposed on the body.

19. The child-monitoring communication system in accordance with claim 11, wherein:
the toy-shaped communication device includes a third sensor operably configured to detect a child's cry; and
the at least one of the audio and visual communication from the remote caretaker is presented to the child, via the output terminal, as a result of the third sensor detecting the child's cry.

20. The child-monitoring communication system in accordance with claim 11, wherein:
the toy-shaped communication device includes a third sensor operably configured to detect a pressure measurement; and
the at least one of the audio and visual communication from the remote caretaker is presented to the child, via the output terminal, as a result of the third sensor detecting a hugging pressure exerted on the body.
